(19) United States
(12) Patent Application Publication
(10) Pub. No.: US 2009/0080612 A1
(43) Pub. Date: Mar. 26, 2009

(54) RADIATION SPECTRUM MEASURING SYSTEM

(75) Inventor: Noriyuki Hikida, Otawara-shi (JP)

Correspondence Address: PILLSBURY WINTHROP SHAW PITTMAN, LLP, P.O. BOX 10500, MCLEAN, VA, 22102, US

(73) Assignees: KABUSHIKI KAISHA TOSHIBA, Tokyo (JP); Toshiba Electron Tubes & Devices Co., Ltd., Otawara-shi (JP)

(21) Appl. No.: 12/238,072

(22) Filed: Sep. 25, 2008

(30) Foreign Application Priority Data
Sep. 26, 2007 (JP) 2007-248655

(51) Int. Cl. G01T 1/36; G01T 1/20

(52) U.S. Cl. 378/82; 250/369

(57) ABSTRACT

According to an aspect of the invention, a radiation spectrum measuring system for measuring a radiation spectrum by using a radiation detection element includes, a radiation spectrum measuring unit for measuring a radiation spectrum by obtaining a pulse signal output from the radiation detection element as data, and a rise time detection unit which detects a rise time of the pulse signal, compares the detected rise time with a preset value, and causes the radiation spectrum measuring unit to exclude from data a pulse signal with a rise time longer than the preset value.

### CROSS-REFERENCE TO RELATED APPLICATIONS

This application is based upon and claims the benefit of priority from prior Japanese Patent Application No. 2007-248655, filed Sep. 26, 2007, the entire contents of which are incorporated herein by reference.

### BACKGROUND OF THE INVENTION

1. Field of the Invention

The present invention relates to a radiation spectrum measuring system for measuring a radiation spectrum.

2. Description of the Related Art

Generally, as shown in FIG. 5, a radiation spectrum measuring system for measuring a radiation spectrum such as X-rays comprises a radiation detector 1 which absorbs radiation and outputs an electric charge corresponding to the radiation energy, a preamplifier 2 which amplifies the micro electric charge output from the radiation detector 1, a waveform shaping module 3 which shapes the waveform of the amplified electric charge, a wave height analysis module 4 which analyzes a radiation wave height, and a computer 5 which is used to collect, display and save data.

In such a radiation spectrum measuring system, a proportional counter tube, a semiconductor detector or a scintillator is used as a radiation detector 1. A proportional counter tube is inferior in the performance such as energy solution, but has long life and cheap price, compared with other types of radiator detector, and is used in a relatively low-cost system (refer to Jpn. Pat. Appln. KOKAI Publication No. 5-28958 (p. 2, FIGS. 1 and 2).

As a preamplifier 2, a charge amplifier to provide a high signal-to-noise ratio is often used in a radiation spectrum measuring apparatus. Only the number of pulses is a problem. A current amplifier may be used as a preamplifier in a radiation spectrum measuring system used for applications in which a wave height distribution is not a serious problem.

A waveform shaping module 3 is a module to shape the waveform of a pulse for the processing convenience in a later stage, when a charge amplifier is used for the preamplifier 2 (refer to Glenn F. Knoll, Radiation Measurement Handbook, 3rd edition, Nikkan Kogyo Shinbun P. 663-664).

A wave height analysis module 4 is used to count the number of pulses in an area including a pulse peak, or to obtain data on the wave height distribution, according to purposes of a system.

When radiation with single energy is applied to a system for obtaining a radiation energy distribution by using a conventional proportional counter tube, a pulse height distribution shown in FIG. 6 can be obtained. In the graph, the horizontal axis indicates a peak value corresponding to energy shifted to gas when the radiation is absorbed by the gas filled in the proportional counter tube, and the vertical axis indicates the number/frequency.

When X-rays with a single frequency (with the same energy) are applied, it is preferable that a signal a with the same wave height is output and a δ-function spectrum is obtained. However, actually, a statistical error occurs in the signal amplitude and the number of created ion pairs, and a wave height distribution b with a certain width is obtained. Besides, the input X-ray energy may be partially damaged, and the pulse peak may become lower than a due peak value. In this case, the wave height distribution becomes substantially uniform on the side lower than the pulse peak close to a due peak value. Hereinafter, the substantially uniform wave height distribution on the side lower than a pulse peak will be called a tail distribution c.

A proportional counter tube is principally used to separate radiation energy. However, as a statistical error causes a width in a pulse peak, the capacity (energy solution) of separating X-rays with different energies is limited.

Further, if a tail distribution c exists, when radiation with different energies is applied to a proportional counter tube, a tail distribution c caused by a high-energy radiation overlaps with a peak caused by a low-energy radiation.

Generally, in an energy dispersion type analyzer, X-rays with higher energy than characteristic X-rays emitted from an element to be measured are applied to a sample. Excitation X-rays with high energy are dispersed by surrounding structures, and are applied to a proportional counter tube together with the X-rays to be measured. Therefore, a lower detection limit of radiation to be measured is restricted by a tail distribution c formed by the dispersion of the excitation X-rays.

For example, in a proportional counter tube used for an S-meter for measuring the amount of sulfur included in oil, the energy of characteristic X-rays of sulfur used for detection is 2.3 keV, and X-rays with energy of about 4 to 7 keV are applied to a sample to excite atoms of sulfur, and characteristic X-rays of 2.3 keV generated from the sulfur is measured. A wave height distribution obtained in this case includes a wave height distribution d formed by the excitation X-rays with high energy dispersed by the sample and applied to a proportional counter tube, and a wave height distribution e formed by the X-rays of 2.3 keV generated by the sulfur to be measured, as shown in FIG. 7. Namely, two wave height distributions are overlapped. However, when the amount of sulfur to be measured is small and the height of the wave high distribution e formed by the 2.3-keV X-rays, the wave height distribution is buried in the tail distribution c of the wave height distribution d formed by the excitation X-rays. Therefore, the existence of the tail distribution c causes a problem that a lower measurement limit of sulfur cannot be decreased.

The present invention has been made in view of the fact described above. Accordingly, it is an object of the invention to provide a radiation spectrum measuring system, which is configured to reduce an influence of a tail distribution of a wave height distribution formed by an excitation radiation, and to decrease a lower measurement limit of an element to be measured.

### BRIEF SUMMARY OF THE INVENTION

According to an aspect of the invention, a radiation spectrum measuring system for measuring a radiation spectrum by using a radiation detection element comprises, a radiation spectrum measuring means for measuring a radiation spectrum by obtaining a pulse signal output from the radiation detection element as data, and a rise time detection means which detects a rise time of the pulse signal, compares the detected rise time with a preset value, and causes the radiation spectrum measuring means to exclude from data a pulse signal with a rise time longer than the preset value.

Additional objects and advantages of the invention will be set forth in the description which follows, and in part will be obvious from the description, or may be learned by practice of the invention. The objects and advantages of the invention may be realized and obtained by means of the instrumentalities and combinations particularly pointed out hereinafter.

### BRIEF DESCRIPTION OF THE SEVERAL VIEWS OF THE DRAWING

The accompanying drawing, which are incorporated in and constitute a part of the specification, illustrate embodiments of the invention, and together with the detailed description of the embodiments given below, serve to explain the principles of the invention.

FIG. 1 is a block diagram of a radiation spectrum measuring system according to an embodiment of the invention;

FIG. 2 is a sectional view of a proportional counter tube in the same radiation spectrum measuring system;

FIG. 3 is a view explaining the reason why not all radiation energies are shifted to gas in the same proportional counter tube;

FIG. 4 is a graph showing a pulse signal with different rise time output from the proportional counter tube;

FIG. 5 is a block diagram of a conventional radiation spectrum measuring system;

FIG. 6 is a graph showing a wave height distribution when X-rays with a single frequency are applied; and

FIG. 7 is a graph showing a wave height distribution when a mass of specific substance is measured by ordinary X-rays.

### DETAILED DESCRIPTION OF THE INVENTION

An embodiment of the invention will be explained hereinafter with reference to the accompanying drawings.

A radiation spectrum measuring system measures a radiation spectrum by using a proportional counter tube 11 shown in FIG. 2 as a radiation detection element or detector.

The proportional counter tube 11 has an outer casing 12 as a cathode, which is formed as an airtight tube made of stainless steel (SUS).

The outer casing 12 is filled with gas 13 as X-ray absorption gas to absorb and electrically separate X-rays as radiation, which is made mainly of inert gas such as Ne, Ar, Kr and Xe, and is added with several percent of molecular gas.

An anode 14 is provided at the axis of the outer casing 12. Both ends of the anode 14 are held by insulators 15 in the outer casing 12. The anode 14 has a small diameter in order to increase the strength of electric field near the anode 14, and to increase a gas amplification factor.

An X-ray input port 16 is formed as a radiation input port on the side of the outer casing 12. The X-ray input port 16 is closed by an X-ray input window 17. The X-ray input window 17 is made of material with excellent X-ray transmissivity, for example, beryllium (Be).

One end of the outer casing 12 is provided with a connector 18, which connects the anode 14 and outer casing 12 as a cathode.

When the energy of input X-rays is absorbed by the gas 13 filled in the proportional counter tube 11, electrons and X-rays with energy lower than the input X-rays are generated by the photoelectric effect. The electrons impinge on the surrounding gas 13, electrically separate the gas 13, and lose the energy. The X-rays with the energy lower than the input X-rays are absorbed again by the gas 13, and electrons and X-rays with lower energy are generated. As a result, the X-ray energy is consumed by the electrical separation of the gas 13, and an ion pair (an electron and ion) of the number corresponding to the input X-ray energy is created.

In the ion pair, an electron is attracted to the central anode 14 by the electric field inside the proportional counter tube 11, and an ion is attracted to the outer casing 12 as a cathode. When an electron comes close to the anode 14, an electron avalanche occurs due to the strong electric field, the number of electrons is increased, and the increased electrons are collected on the anode 14. The ions generated by the electron avalanche are moved to the outer casing 12 as a cathode, and are finally collected in the outer casing 12 as a cathode. This movement of charged particles creates an electrical signal.

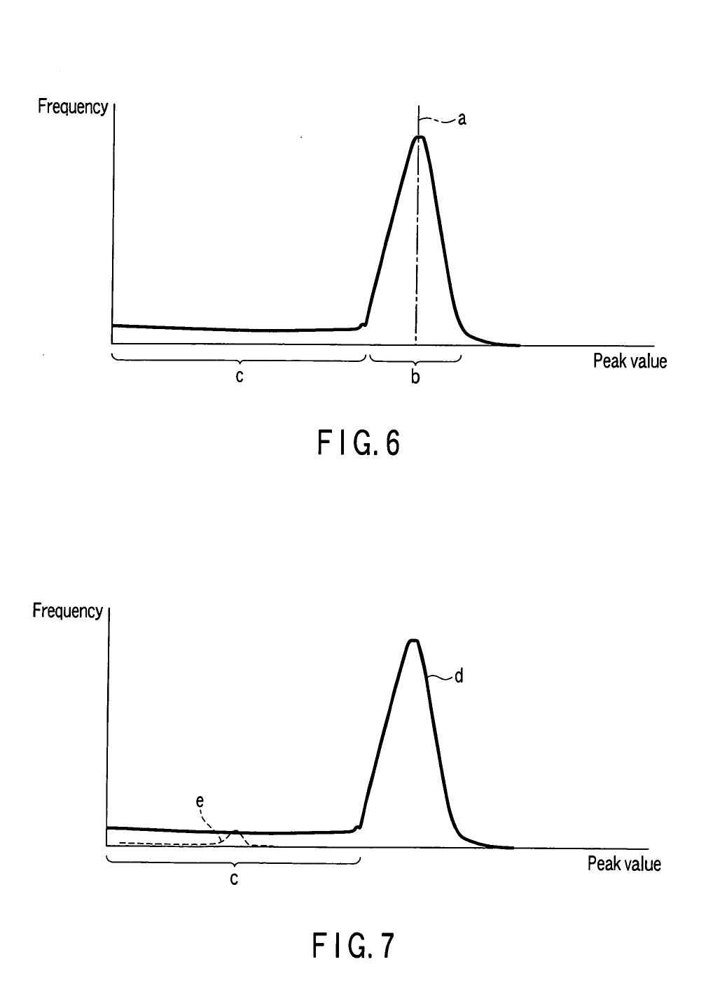

Next, an explanation will be given on the cause of generation of the tail distribution c in a spectrum as shown in FIG. 6.

A main cause of generation of the tail distribution c is that only a part of the energy is shifted to the gas 13 when the absorbed X-ray energy is shifted to the gas 13 in the proportional counter tube, and the number of generated ion pairs is less than a due number. Mode to shift only a part of X-ray energy occurs in the following two cases.

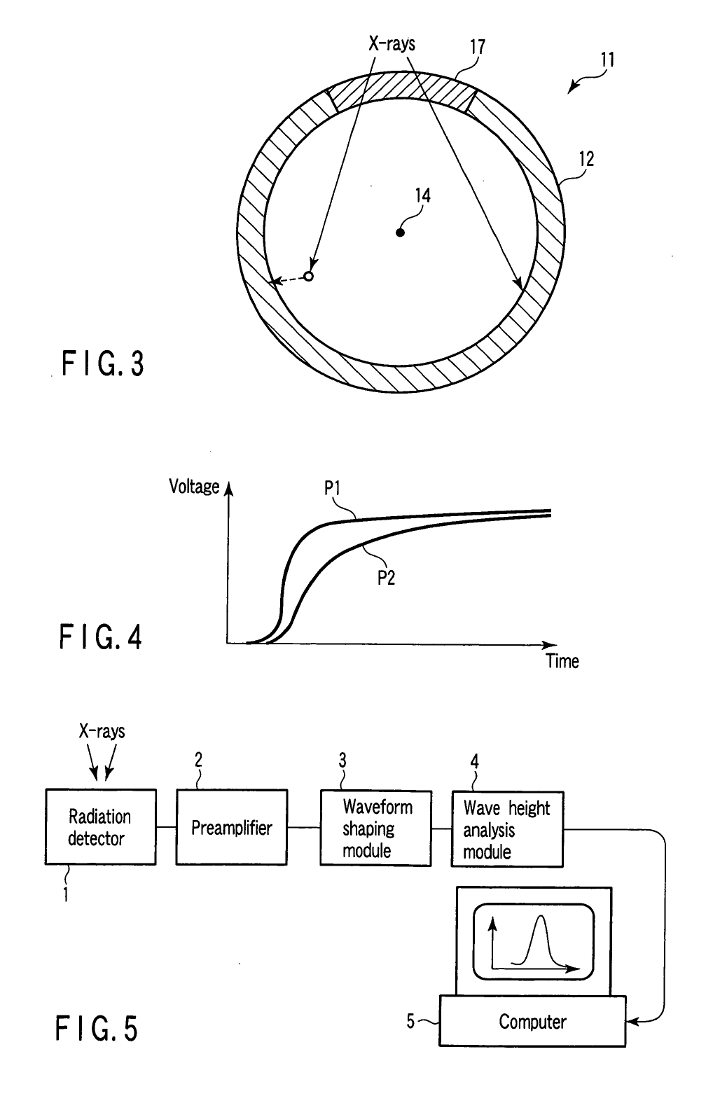

The first case is that when X-rays are absorbed near the outer casing 12, the generated electrons or X-rays impinge on the outer casing as a cathode before all energies are given to the gas 13, as shown in FIG. 3. In this case, a part of the X-ray energy is absorbed by the outer casing 12 as a cathode, and becomes loss, and the number of generated ion pairs is less than a due number.

The second case is that secondary electrons are also generated in the case where X-rays are not absorbed by the gas 13 in the proportional counter tube 11, but are absorbed by the outer casing 12 as a metallic cathode, as in the case where X-rays are absorbed by the gas 13. However, as metal rejects electrons greater than the gas 13 does, and in most cases, electrons lose all energy in the outer casing 12 as a cathode. However, when X-rays are absorbed near the inside surface of the outer casing 12 as a cathode, generated electrons do not completely remain in the outer casing 12 as a cathode, and comes out to the gas 13. The electrons coming out to the gas 13 lose a part of energy during running in the outer casing 12 as a cathode. The energy lost in the gas 13 is a part of input X-rays, and the number of generated ion pairs becomes smaller than a due number.

There are more than one processes of generating pulses to form the tail distribution c, but X-ray energy in any processes is shifted to the gas 13 near the outer casing 12 as a cathode. Therefore, if it is confirmed that X-rays are absorbed near the outer casing 12 as a cathode, it is possible to determine whether a pulse signal output from the proportional counter tube 11 is generated as a result of losing a part of X-ray energy.

Next, an explanation will be given on the principle of the above determination.

A position inside the proportional counter tube 11 where X-rays are absorbed can be known by observing the rise time of a pulse signal output from the proportional counter tube 11, as shown in FIG. 4. Namely, when a pulse signal P1 with a short rise time is generated, X-rays are absorbed at a position near the anode 14. When a pulse signal P2 with a long rise time is generated, X-rays are absorbed at a position far from the anode 14. The reason will be described below.

In an ion pair generated by absorbing X-rays, an electron is attracted to the central anode 14 by the electric field inside the proportional counter tube 11, and an ion is attracted to the outer casing 12 as a cathode. As described hereinbefore, when an electron comes close to the anode 14, an electron avalanche occurs due to the strong electric field, the number of electrons is increased, and the increased electrons are collected to the anode 14. The ions generated by the electron avalanche are moved to the outer casing 12 as a cathode. This movement of charged particles creates an electrical signal. An output signal of the proportional counter tube 11 is formed by the movement of the ions generated by the electron avalanche to the outer casing 12 (refer to Glenn F. Knoll, Radiation Measurement Handbook, 3rd edition, Nikkan Kogyo Shinbun P. 203-208).

Therefore, the rise time of the pulse signal output from the proportional counter tube 11 is likely to be considered determined only by the flow velocity of ions. However, as an ion pair formed first by input X-rays is spread in the range determined by the X-ray energy and gas composition, a range is given to the time required by the electrons generated by the input X-rays to reach the area near the anode 14 where an electron avalanche occurs. By this time range, a pulse signal rise time becomes longer than the rise time of a pulse signal determined only by the flow velocity of ions (refer to Glenn F. Knoll, Radiation Measurement Handbook, 3rd edition, Nikkan Kogyo Shinbun P. 203-208).

Generally, the proportional counter tube 11 comprises the anode 14 and outer casing 12 as a cathode, as shown in FIG. 2. The anode 14 is a thin metallic wire, and the outer casing 12 as a cathode is a metallic tube. The electric field strength is decreased in an area closer to the outer casing 12 as a cathode, and the time range for electrons to reach the anode 14 is increased when the position to absorb X-rays and to generate an ion pair is closer to the outer casing 12 as a cathode. As a result, rising of a pulse signal is delayed. Therefore, pulse signals forming the tail distribution c can be removed by excluding a pulse signal with a long rise time.

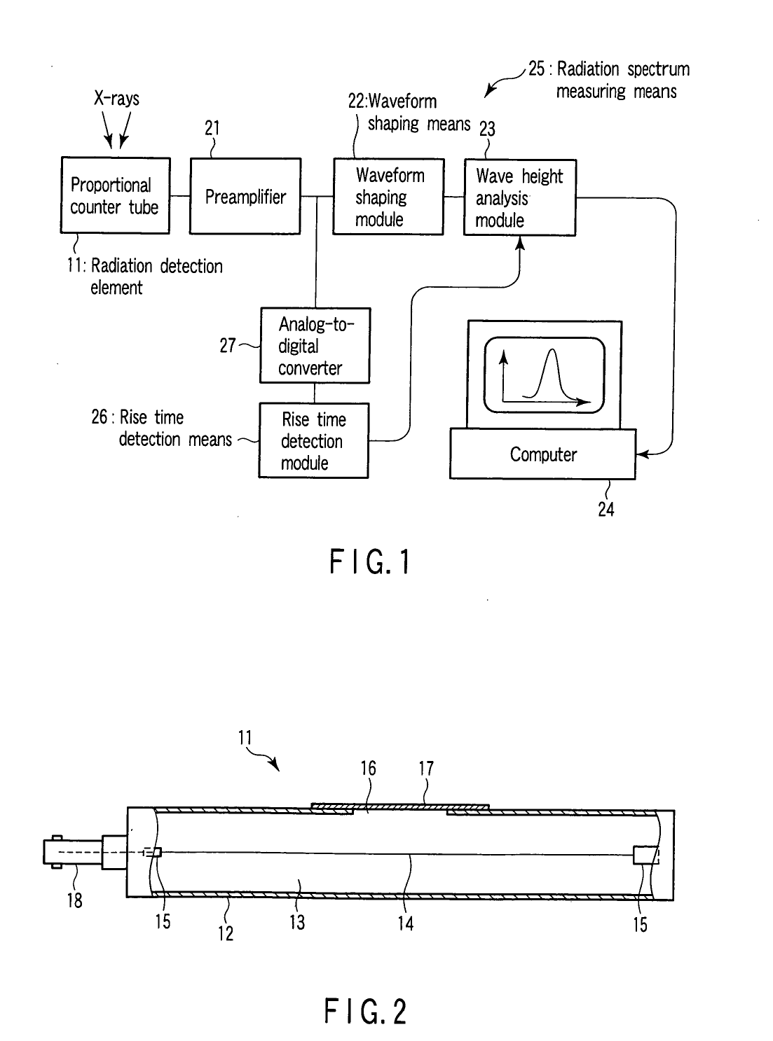

FIG. 1 shows a radiation spectrum measuring system. The radiation spectrum measuring system comprises a proportional counter tube 11, a charge-amplifying preamplifier 21 (a charge amplifier) to provide a high signal-to-noise ratio for amplifying a micro charge output from the proportional counter tube 11, a waveform shaping module 22 as a waveform shaping means for shaping the waveform of a pulse for the processing convenience in a later stage, when the charge-amplifying preamplifier 21 is used, a wave height analysis module 23 which counts only the number of pulse signals in an area including a pulse peak, or analyzes wave height by obtaining wave height distribution data of pulse signals, according to purposes of a system, and a computer 24 (a multi-channel analyzer for collecting a wave height distribution data) for collecting, displaying and saving data. These preamplifier 21, waveform shaping module 22, wave height analysis module 23 and computer 24 form a radiation spectrum measuring means 25, which captures a pulse signal output from the proportional counter tube 11 as data, and measures a spectrum of X-rays as radiation.

The radiation spectrum measuring system has a rise time detection module 26 as a rise time detection means. The rise time detection module 26 measures the rise time of a pulse signal output from the preamplifier 21, and sends a signal not to obtain the pulse height data to the wave height analysis module 23, when the rising rime is longer than a preset value. For example, the rise time detection module 26 converts the output of the preamplifier 21 to a digital signal by an analog-to-digital converter 27, obtains a pulse peak and rising from the time history of the electrical signal strength by an arithmetic unit using FPGA and CPDL, for example, of the rise time detection module 26, and as a result, determines whether to send the signal not to obtain the pulse height data to the wave height analysis module 23 corresponding to the obtained rise time.

As for the processing speed of the arithmetic unit of the rise time detection module 26, though the rise time of the output of the preamplifier 21 varies depending on the composition of the gas 13 in the proportion counter tube 11, the dimensions of the proportion counter tube 11, and the input X-ray energy, it comes within a range of 0.1 to 1 μs. Therefore, approximately 100 MSPS is required as a sampling rate of the analog-to-digital converter 27.

As described above, the rise time of the pulse signal output from the proportional counter tube 11 and amplified by the preamplifier 21 is detected, and compared with a preset value. The pulse signal with the rise time shorter than the preset value is taken in as data by the wave height analysis module 23, and the pulse signal with the rise time longer than the preset value is not taken in as data by the wave height analysis module 23. As a result, the influence of the tail distribution c in a wave height distribution formed by excitation X-rays can be reduced, and the lower measurement limit of an element to be measure can be lowered.

Additional advantages and modifications will readily occur to those skilled in the art. Therefore, the invention in its broader aspects is not limited to the specific details and representative embodiments shown and described herein. Accordingly, various modifications may be made without departing from the spirit or scope of general inventive concept as defined by appended claims and their equivalents.

What is claimed is:

1. A radiation spectrum measuring system for measuring a radiation spectrum by using a radiation detection element, comprising:
a radiation spectrum measuring means for measuring a radiation spectrum by obtaining a pulse signal output from the radiation detection element as data; and
a rise time detection means which detects a rise time of the pulse signal, compares the detected rise time with a preset value, and causes the radiation spectrum measuring means to exclude from data a pulse signal with a rise time longer than the preset value.

2. The radiation spectrum measuring system according to claim 1, wherein the radiation detection element is a proportional counter tube.

3. The radiation spectrum measuring system according to claim 1, further comprising a preamplifier to amplify the output of the radiation detection element,
wherein the rise time detection means detects a rise time of the pulse signal output from the preamplifier.
